(19) United States
(12) Patent Application Publication
(10) Pub. No.: US 2017/0264685 A1
(43) Pub. Date: Sep. 14, 2017

(54) DISTRIBUTION METHOD, DISTRIBUTION REQUEST METHOD, AND INFORMATION PROCESSING DEVICE

(71) Applicant: FUJITSU LIMITED, Kawasaki-shi (JP)

(72) Inventors: Atsuko Tada, Tokorozawa (JP); Ryuta Tanaka, Machida (JP); Ryoichi Funabashi, Kawasaki (JP); Motoo Masui, Inagi (JP)

(73) Assignee: FUJITSU LIMITED, Kawasaki-shi (JP)

(21) Appl. No.: 15/455,716

(22) Filed: Mar. 10, 2017

(30) Foreign Application Priority Data
Mar. 14, 2016 (JP) 2016-050274

(51) Int. Cl. H04L 29/08

(52) U.S. Cl. CPC H04L 67/1095; H04L 67/06

(57) ABSTRACT

A distribution method includes assigning, to each of files including divided video data which is divided in accordance with a time series, identification information that includes information indicating one of the video data and information indicating an order of the time series, receiving, from a terminal device that reproduces the files, a distribution request for video data based on a pseudo definition file in which pseudo identification information is defined in a reproduction order of reproducing the files, selecting, based on relationship information indicating a correspondence relationship between the pseudo identification information and the identification information, a file corresponding to the distribution request from among the files, and distributing the selected file to the terminal device.

### CROSS-REFERENCE TO RELATED APPLICATION

This application is based upon and claims the benefit of priority of the prior Japanese Patent Application No. 2016-050274, filed on Mar. 14, 2016, the entire contents of which are incorporated herein by reference.

### FIELD

The embodiments discussed herein are related to a technology for controlling reproduction of video data.

### BACKGROUND

There is a technology for distributing, via a network, divided files to a terminal device equipped with a function of reproducing video data, thereby controlling reproduction of the video data in the terminal device, the divided files being obtained by dividing, in accordance with a time series, pieces of video data continuous in a time-series manner.

As such a technology, there is a technology in which a reproduction control device sequentially selects divided files selected from divided files obtained by dividing individual pieces of video data, thereby transmitting the selected divided files to a terminal device.

According to the relevant technology, it becomes possible to distribute pieces of video data to each of terminal devices in accordance with a preference of a client who watches videos by using the relevant terminal device, the pieces of video data being obtained by so-called multi-angle image-capturing, that is, by being image-captured from different angles by use of image-capturing devices, for example.

As such a technology, there is a technology in which a terminal device requests, based on a distribution list, a reproduction control device to distribute video data, thereby distributing the requested video data from the reproduction control device, the distribution list being obtained by defining a distribution order of pieces of video data by using link names linked to the pieces of video data. In this technology, the reproduction control device creates a linked list, in which link names and video data file names are associated with each other, and provides the linked list to the terminal device. In this technology, the terminal device updates a video data name in the provided linked list to another video data file name, thereby enabling video data to be distributed to be changed.

A related technology is disclosed in, for example, International Publication Pamphlet No. WO 2002/082817.

### SUMMARY

According to an aspect of the invention, a distribution method includes assigning, to each of files including divided video data which is divided in accordance with a time series, identification information that includes information indicating one of the video data and information indicating an order of the time series, receiving, from a terminal device that reproduces the files, a distribution request for video data based on a pseudo definition file in which pseudo identification information is defined in a reproduction order of reproducing the files, selecting, based on relationship information indicating a correspondence relationship between the pseudo identification information and the identification information, a file corresponding to the distribution request from among the files, and distributing the selected file to the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a schematic configuration of an entire video reproduction system according to a first embodiment;

FIG. 2 is a diagram for explaining a specific example of multi-angle image-capturing;

FIG. 3 is a functional block diagram illustrating a schematic configuration of the video reproduction system according to the first embodiment;

FIG. 4 is a diagram illustrating a specific example of video data;

FIG. 5 is a diagram illustrating a specific example of a watching angle selection table;

FIG. 6 is a block diagram illustrating a schematic configuration of hardware for realizing a reproduction control device according to the first embodiment;

FIG. 7 is a block diagram illustrating a schematic configuration of hardware for realizing a cache server according to the first embodiment;

FIG. 8 is a block diagram illustrating a schematic configuration of hardware for realizing a terminal device according to the first embodiment;

FIG. 9 is a flowchart of an example of correspondence table creation processing performed in the terminal device according to the first embodiment;

FIG. 10 is a flowchart of an example of initializing processing in the correspondence table creation processing according to the first embodiment;

FIG. 11 is a flowchart of an example of update processing in the correspondence table creation processing according to the first embodiment;

FIG. 12 is a flowchart of an example of angle selection processing performed in the reproduction control device according to the first embodiment;

FIG. 13 is a flowchart of an example of initializing processing in the angle selection processing according to the first embodiment;

FIG. 14 is a flowchart of an example of update processing in the angle selection processing according to the first embodiment;

FIG. 15 is a sequence diagram illustrating a flow of processing performed between the reproduction control device, the cache server, and the terminal device in order to create a correspondence table according to the first embodiment;

FIG. 16 is a diagram illustrating a specific example of the correspondence table;

FIG. 17 is an explanatory diagram for explaining an outline of flows of segment files requested and distributed between the reproduction control device, the cache server, and terminal devices in order to distribute the segment files;

FIG. 18 is a sequence diagram illustrating a flow of processing performed between the reproduction control device, the cache server, and terminal devices in order to distribute segment files;

FIG. 19 is a flowchart of an example of translation processing performed in the terminal device of the first embodiment;

FIG. 20 is a diagram illustrating a specific example of a pseudo definition file;

FIG. 21 is a flowchart of an example of distribution processing performed in the cache server of the first embodiment;

FIG. 22 is a flowchart of an example of distribution processing performed in the reproduction control device of the first embodiment;

FIG. 23 is a functional block diagram illustrating a schematic configuration of a video reproduction system according to a second embodiment;

FIG. 24 is a functional block diagram illustrating a schematic configuration of a video reproduction system according to a third embodiment; and

FIG. 25 is an explanatory diagram for explaining an outline of flows of segment files requested and distributed between a reproduction control device, a cache server, and terminal devices in a video reproduction system to serve as a comparative example.

### DESCRIPTION OF EMBODIMENTS

In some cases, each of terminal devices requests, via a network, a reproduction control device to distribute video data (divided files) corresponding to a preference of a client who watches videos by using the relevant terminal device. In such a case, the number of times hypertext markup languages (HTMLs) in which segments are defined are updated is increased. Accordingly, the data amount of video data distributed via the network is increased, thereby increasing a network load.

In one aspect, an object of the technology disclosed in embodiments is to reduce a load on a network via which video data is distributed.

Hereinafter, examples of the disclosed technology will be described in detail with reference to drawings.

### First Embodiment

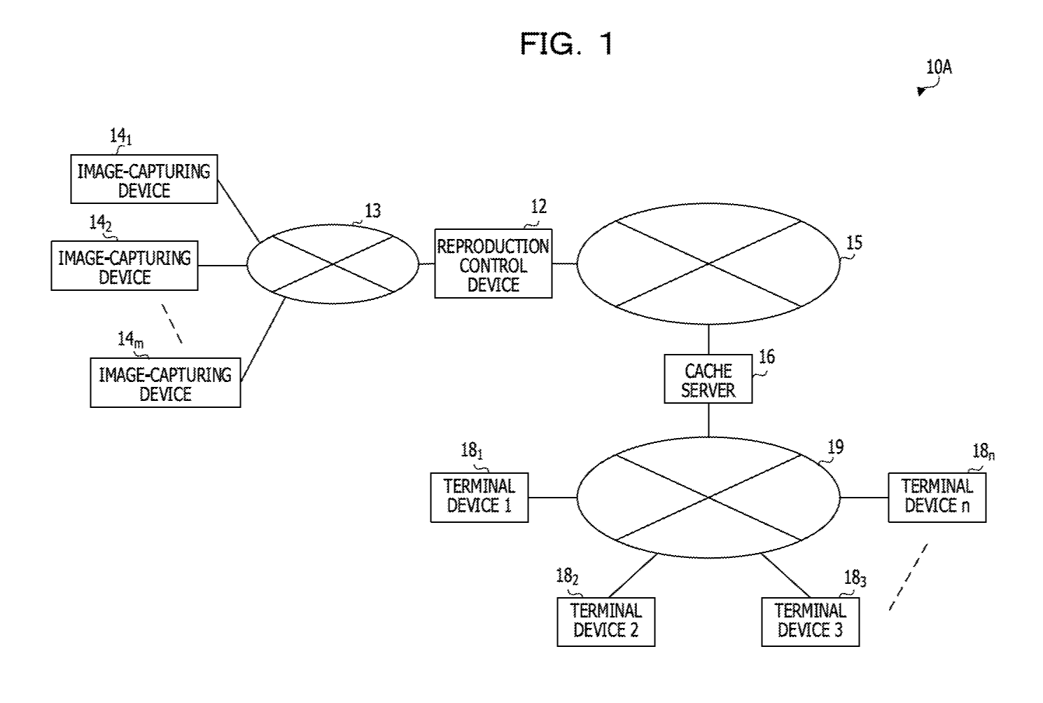

As illustrated in FIG. 1, a video reproduction system 10A of the present embodiment includes a reproduction control device 12, image-capturing devices 14₁ to 14ₘ (“M” is a positive integer), a cache server 16, and terminal devices 18₁ to 18ₙ (“n” is a positive integer). In what follows, in a case where the image-capturing devices 14₁ to 14ₘ are collectively called while not being distinguished from one another, the image-capturing devices 14₁ to 14ₘ are described as “image-capturing devices 14” while the descriptions of “1” to “m” that indicate the respective image-capturing devices 14 are omitted. In addition, in a case where the terminal devices 18₁ to 18ₙ are collectively called while not being distinguished from one another, the terminal devices 18₁ to 18ₙ are described as “terminal devices 18” while the descriptions of “1” to “n” that indicate the respective terminal devices 18 are omitted.

As illustrated in FIG. 1, the reproduction control device 12 and the image-capturing devices 14 are coupled to one another via a network 13. The reproduction control device 12 and the cache server 16 are coupled to each other via a network 15. In addition, the cache server 16 and the terminal devices 18 are coupled to one another via a network 19.

Note that the networks 13, 15, and 19 may be separate networks or may be the same network.

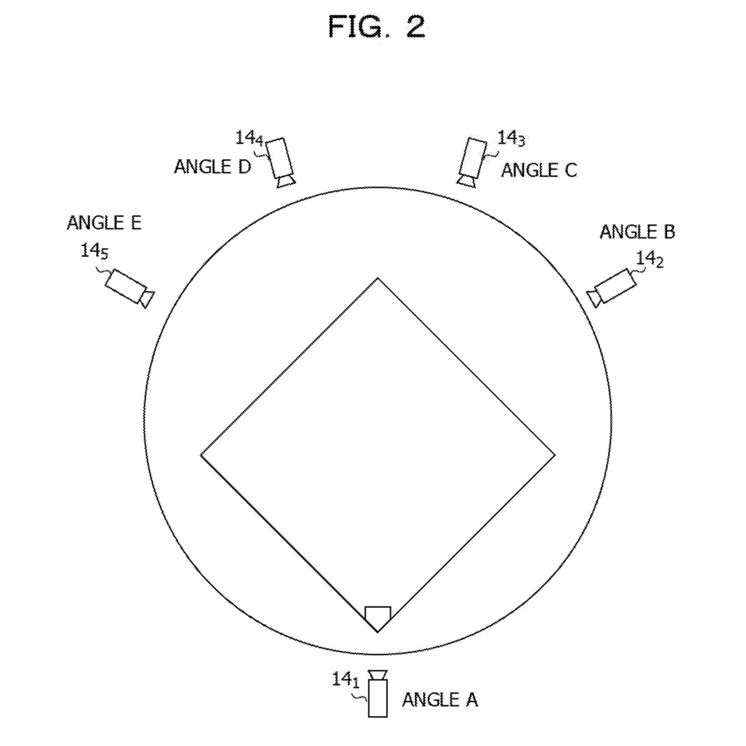

The image-capturing devices 14 are each equipped with a function of image-capturing videos and are so-called cameras or the like. As illustrated as a specific example in FIG. 2, the image-capturing devices 14 of the present embodiment perform so-called multi-angle image-capturing, that is, image-capturing an image-capturing target at angles. The specific example illustrated in FIG. 2 illustrates a case where the video reproduction system 10A includes five (m=5) image-capturing devices 14, thereby performing baseball relay at multiple angles. The image-capturing devices 14 each transmit, to the reproduction control device 12 via the network 13, image data (hereinafter, called “video data”) of image-captured videos. Each of the pieces of video data is time-series data in which pieces of data are continuous in a time-series manner.

The reproduction control device 12 distributes, to the terminal devices 18 via the cache server 16, pieces of video data received from the image-capturing devices 14, thereby controlling reproduction of videos in the terminal devices 18.

By using a method for sequentially distributing, based on hypertext transfer protocols (HTTPs), segment files each obtained by dividing a series of pieces of video data for each predetermined time period (for example, 10 seconds), the reproduction control device 12 of the present embodiment distributes the segment files to the terminal devices 18. As the distribution method, HTTP Live Streaming (HLS), Moving Picture Experts Group, dynamic adaptive streaming over HTTP (MPEG-DASH), and so forth are cited, for example. Note that “series” in the present embodiment indicates being continuous in a time-series manner. The segment files are examples of the divided files of the disclosed technology.

Each of the terminal devices 18 requests the reproduction control device 12 to distribute video data and receives and displays the requested video data.

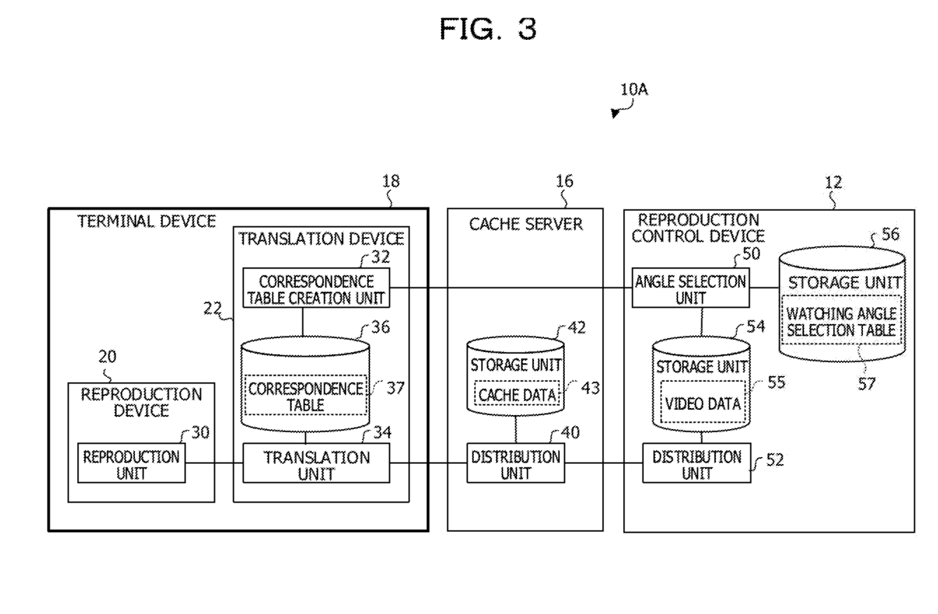

FIG. 3 is a functional block diagram illustrating a schematic configuration of a video reproduction system according to the first embodiment.

Each of the terminal devices 18 of the present embodiment includes a translation device 22 to request the reproduction control device 12 to distribute video data 55 and to receive the requested video data 55, and a reproduction device to cause video data to be displayed on a display device (the illustration thereof is omitted). Note that the display device to display the video data is a so-called display or the like and may be included in each of the terminal devices 18 or may be installed outside each of the terminal devices 18 while being coupled to the relevant terminal device 18.

Note that, in a case where one of the terminal devices 18 transmits, to the reproduction control device 12, various kinds of signals for requesting to distribute and so forth, the relevant terminal device 18 adds, to the relevant signals, identification information used by the reproduction control device 12 to identify the terminal device 18 serving as a transmission source and transmits the identification information. For this reason, the reproduction control device 12 is able to identify the terminal device 18 serving as a transmission source of a received signal.

As illustrated in FIG. 3, the reproduction control device 12 includes an angle selection unit 50, a distribution unit 52, a storage unit 54, and a storage unit 56.

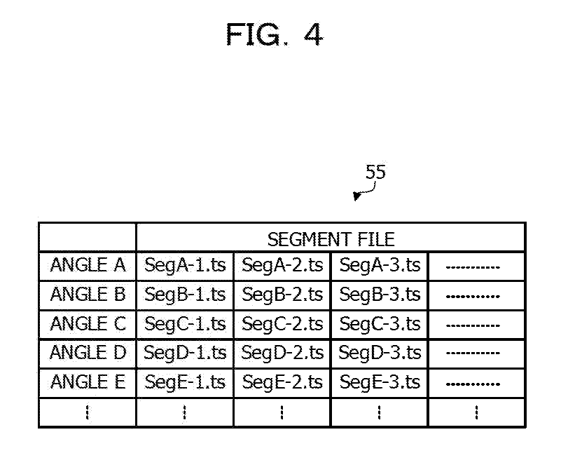

In the storage unit 54, the video data 55 image-captured by the image-capturing devices 14 is stored. Note that, as illustrated in FIG. 4, in the reproduction control device 12 of the present embodiment, for each of the image-capturing devices 14 (an angle k: a corresponding one of k=A to E in the specific example of FIG. 2), segment files obtained by dividing video data for each of predetermined time periods are stored in the storage unit 54.

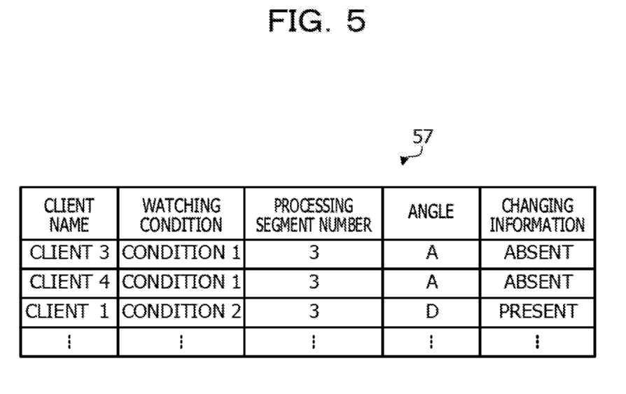

In the storage unit 56, there is stored a watching angle selection table 57 (see FIG. 5: the details thereof will be described later) that corresponds to watching conditions of the respective terminal devices 18 (clients who each watch videos by use of a corresponding one of the terminal devices 18).

The angle selection unit 50 selects an angle corresponding to a watching condition of a corresponding one of the clients for each of segments and describes a selection result in the watching angle selection table 57 stored in the storage unit 56. In addition, based on the watching angle selection table 57, the angle selection unit 50 of the present embodiment outputs, to a corresponding one of the terminal devices 18, information for updating a correspondence table 37.

The distribution unit 52 distributes segment files as the video data 55 requested by a corresponding one of the terminal devices 18 via the cache server 16.

On the other hand, as illustrated in FIG. 3, the cache server 16 includes a distribution unit 40 and a storage unit 42.

The storage unit 42 temporarily stores, as cache data 43, segment files distributed by the distribution unit 52 in the reproduction control device 12.

In a case where a segment file corresponding to a segment file name requested by a corresponding one of the terminal devices 18 is stored as the cache data 43, the distribution unit 40 reads and distributes the segment file from the storage unit 42 and to the relevant terminal device 18. In addition, in a case where the segment file is not stored as the cache data 43, the distribution unit 40 requests the reproduction control device 12 to distribute and distributes, to the relevant terminal device 18, the segment file distributed by the reproduction control device 12. Note that the “segment file name” in the present embodiment is an example of identification information for identifying a corresponding segment file and is generated based on a preliminarily defined rule. While details will be described later, the correspondence table creation unit 32 generates a real segment file name from, for example, a segment number (s) and information indicating the angle k, which are received.

On the other hand, as illustrated in FIG. 3, the terminal devices 18 each include a reproduction device 20 and the translation device 22.

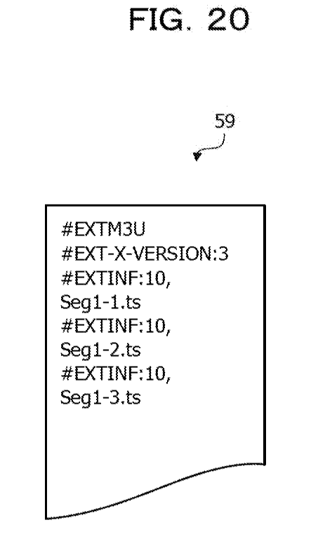

The reproduction device 20 includes a reproduction unit 30. The reproduction unit 30 performs control for causing a display device to sequentially display (reproduce) segment files output by the translation device 22. Specifically, based on a pseudo definition file 59 (see FIG. 20: the details thereof will be described later), the reproduction unit 30 of the present embodiment requests distribution or performs reproduction. Therefore, the reproduction unit 30 requests to distribute a segment file corresponding to a segment file name (hereinafter, called a “pseudo segment file name”) in the pseudo definition file 59.

The translation device 22 includes a correspondence table creation unit 32, a translation unit 34, and a storage unit 36. The storage unit 36 stores therein the correspondence table 37 that indicates a correspondence relationship between pseudo segment file names and actual segment file names (hereinafter, called “real segment file names”) assigned to segment files.

Based on information that is used for updating the correspondence table 37 and that is output by the angle selection unit 50 in the reproduction control device 12, the correspondence table creation unit 32 creates and updates the correspondence table 37. The correspondence table creation unit 32 of the present embodiment is an example of an assignment unit of the disclosed technology.

Based on the correspondence table 37 stored in the storage unit 36, the translation unit 34 performs translation between pseudo segment file names and real segment file names.

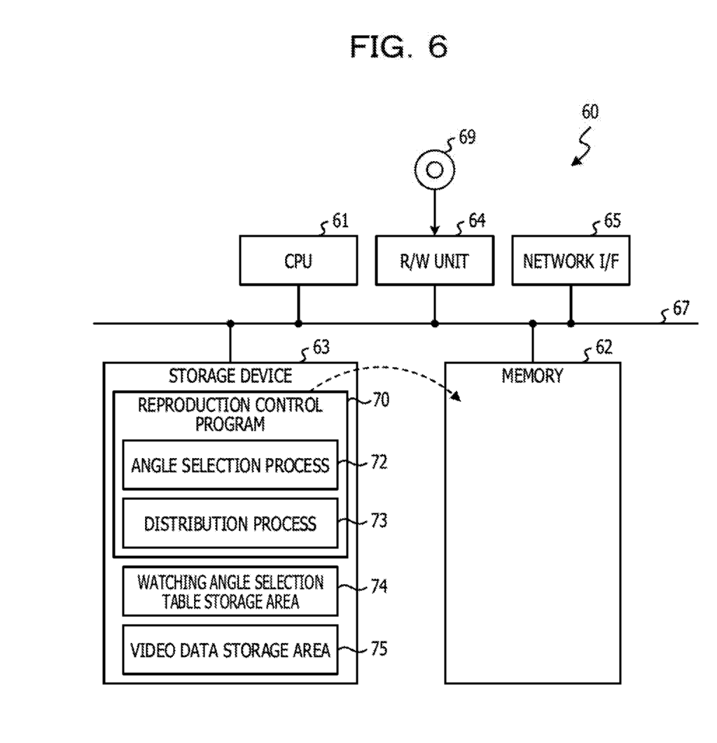

The reproduction control device 12 of the present embodiment may be realized by a computer 60 illustrated in, for example, FIG. 6. The computer 60 includes a CPU 61, a memory 62 serving as a temporary storage area, and a non-volatile storage unit 63. In addition, the computer 60 includes a read and write (R/W) unit 64 to control reading and writing data from and to a recording medium 69, and a network I/F 65 to be coupled to a network such as the Internet. The CPU 61, the memory 62, the storage unit 63, the R/W unit 64, and the network I/F 65 are coupled to one another via a bus 67.

The storage unit 63 may be realized by a hard disk drive (HDD), a solid state drive (SSD), a flash memory, or the like. In the storage unit 63 as a storage medium, a reproduction control program 70 for causing the computer 60 to function as the reproduction control device 12 is stored. The reproduction control program 70 includes an angle selection process 72 and a distribution process 73.

The CPU 61 reads and deploys the reproduction control program 70 from the storage unit 63 and in the memory 62 and sequentially performs processes included in the reproduction control program 70. The CPU 61 performs the angle selection process 72, thereby operating as the angle selection unit 50 illustrated in FIG. 3. In addition, the CPU 61 performs the distribution process 73, thereby operating as the distribution unit 52 illustrated in FIG. 3. For this reason, the computer 60 that executes the reproduction control program 70 turns out to function as the reproduction control device 12.

In addition, a watching angle selection table storage area 74 in the storage unit 63 functions as the storage unit 56 in which the watching angle selection table 57 (see FIG. 5) is stored. A video data storage area 75 in the storage unit 63 functions as the storage unit 54 (see FIG. 3) in which the video data 55 is stored.

Note that functions realized by the reproduction control program 70 may be realized by, for example, a semiconductor integrated circuit, in more detail, an application specific integrated circuit (ASIC) or the like.

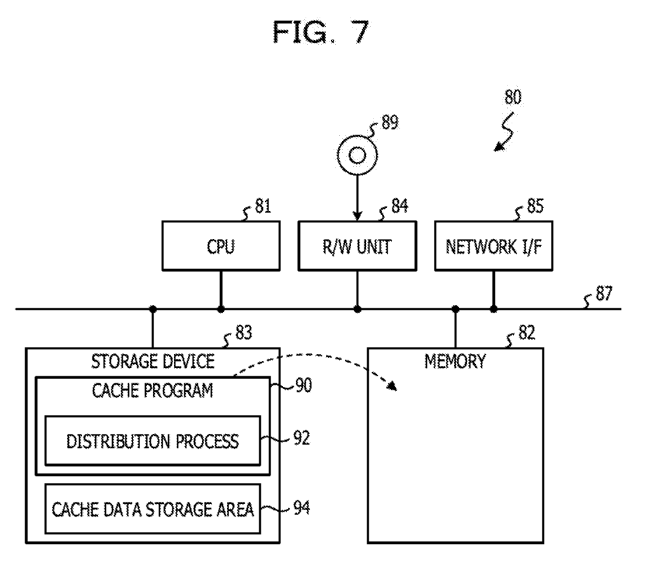

On the other hand, the cache server 16 of the present embodiment may be realized by a computer 80 illustrated in, for example, FIG. 7. The computer 80 includes a CPU 81, a memory 82 serving as a temporary storage area, and a non-volatile storage unit 83. In addition, the computer 80 includes an R/W unit 84 to control reading and writing data from and to a recording medium 89, and a network I/F 85 to be coupled to a network such as the Internet. The CPU 81, the memory 82, the storage unit 83, the R/W unit 84, and the network I/F 85 are coupled to one another via a bus 87.

The storage unit 83 may be realized by an HDD, an SSD, a flash memory, or the like. In the storage unit 83 as a storage medium, a cache program 90 for causing the computer 80 to function as the cache server 16 is stored. The cache program 90 includes a distribution process 92.

The CPU 81 reads and deploys the cache program 90 from the storage unit 83 and in the memory 82 and performs processes included in the cache program 90. The CPU 81 performs the distribution process 92, thereby operating as the distribution unit 40 illustrated in FIG. 3. For this reason, the computer 80 that executes the cache program 90 turns out to function as the cache server 16.

In addition, a cache data storage area 94 in the storage unit 83 functions as the storage unit 42 (see FIG. 3) in which the cache data 43 is stored.

Note that functions realized by the cache program 90 may be realized by, for example, a semiconductor integrated circuit, in more detail, an ASIC or the like.

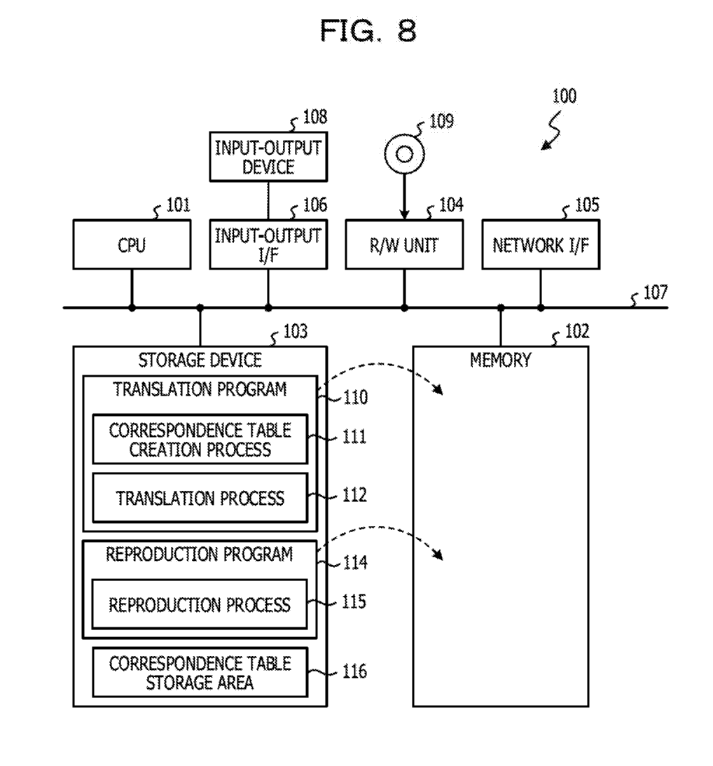

On the other hand, each of the terminal devices 18 of the present embodiment may be realized by a computer 100 illustrated in, for example, FIG. 8. The computer 100 includes a CPU 101, a memory 102 serving as a temporary storage area, and a non-volatile storage unit 103. In addition, the computer 100 includes an R/W unit 104 to control reading and writing data from and to a recording medium 109, and a network I/F 105 to be coupled to a network such as the Internet. In addition, the computer 100 includes an input-output interface (I/F) 106 to which an input-output device 108 such as a display device and an input device is to be coupled. The CPU 101, the memory 102, the storage unit 103, the R/W unit 104, the network I/F 105, and the input-output I/F 106 are coupled to one another via a bus 107.

The storage unit 103 may be realized by an HDD, an SSD, a flash memory, or the like. In the storage unit 103 as a storage medium, a translation program 110 and a reproduction program 114 that are used for causing the computer 100 to function as a corresponding one of the terminal devices 18 are stored. The translation program 110 includes a correspondence table creation process 111 and a translation process 112.

The CPU 101 reads and deploys the translation program 110 from the storage unit 103 and in the memory 102 and sequentially performs processes included in the translation program 110. The CPU 101 performs the correspondence table creation process 111, thereby operating as the correspondence table creation unit 32 illustrated in FIG. 3. In addition, the CPU 101 performs the translation process 112, thereby operating as the translation unit 34 illustrated in FIG. 3. For this reason, the computer 100 that executes the translation program 110 turns out to function as the translation device 22 in a corresponding one of the terminal devices 18.

In addition, the CPU 101 reads and deploys the reproduction program 114 from the storage unit 103 and in the memory 102 and performs processes included in the reproduction program 114. The CPU 101 performs a reproduction process 115, thereby operating as the reproduction unit 30 illustrated in FIG. 3. For this reason, the computer 100 that executes the reproduction program 114 turns out to function as the reproduction device 20 in a corresponding one of the terminal devices 18.

In addition, the correspondence table storage area 116 in the storage unit 103 functions as the storage unit 36 (see FIG. 3) in which the correspondence table 37 is stored.

Note that functions realized by the translation program 110 and the reproduction program 114 may be realized by, for example, a semiconductor integrated circuit, in more detail, an ASIC or the like.

Next, operations of the video reproduction system 10A of the present embodiment will be described.

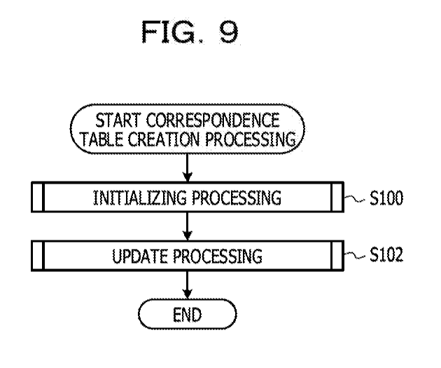

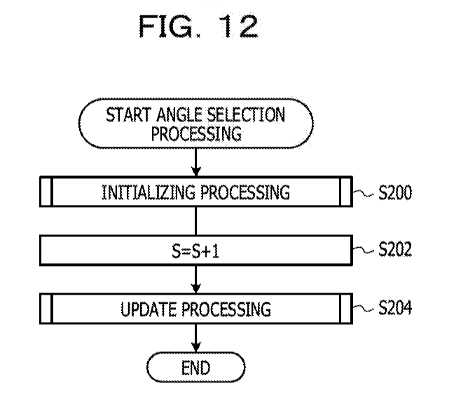

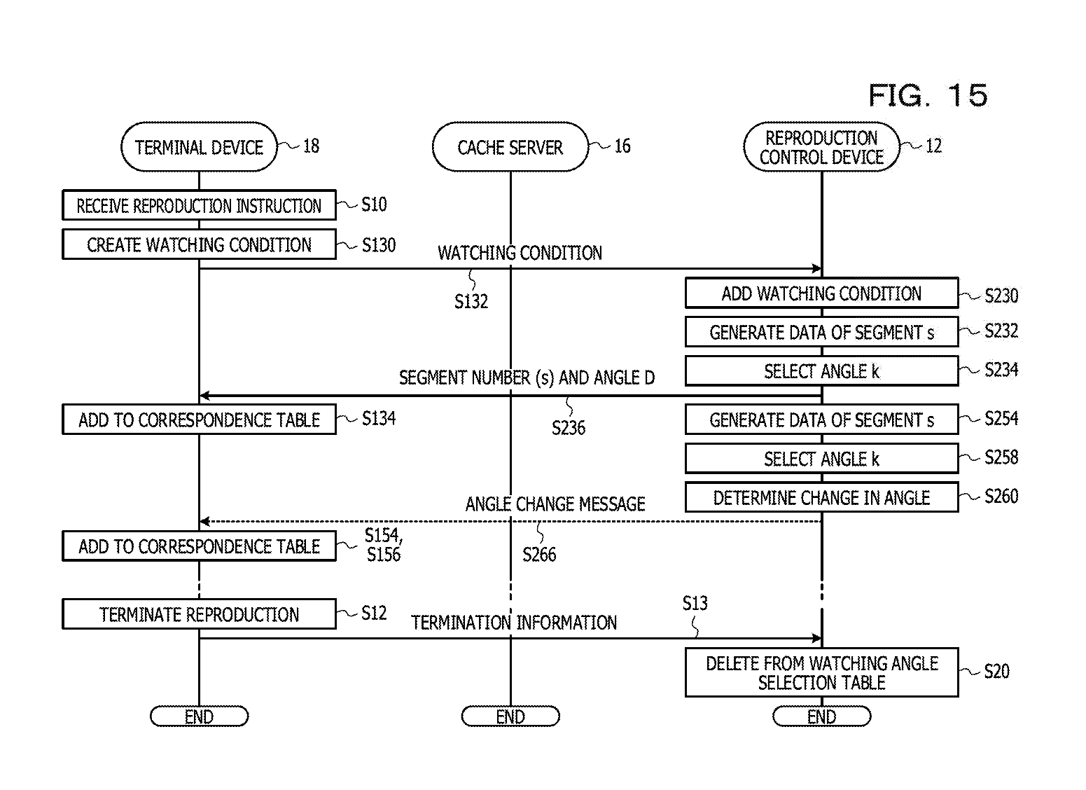

In the video reproduction system 10A of the present embodiment, in a case where one of the terminal devices 18 initiates reproduction of the video data 55, the relevant terminal device 18 performs correspondence table creation processing illustrated in FIGS. 9 to 11 in order for the relevant terminal device 18 to create the correspondence table 37. In addition, the reproduction control device 12 performs angle selection processing illustrated in FIGS. 12 to 14. FIG. 15 is a sequence diagram illustrating a flow of processing performed between the reproduction control device 12, the cache server 16, and one of the terminal devices 18 in order to create the correspondence table 37. Note that while, in FIG. 15, only one of the terminal devices 18 included in the video reproduction system 10A is described, the terminal devices 18 each perform the same operation as that of the illustrated terminal device 18.

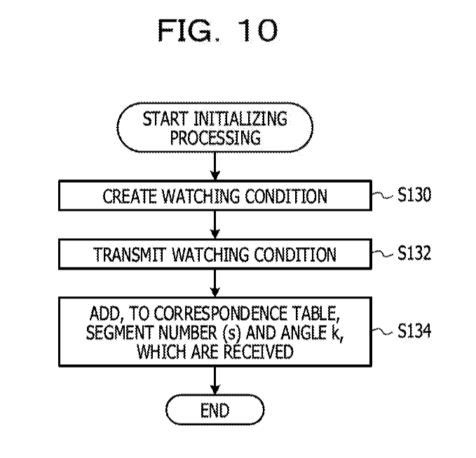

As illustrated in FIG. 15, in the corresponding one of the terminal devices 18, in a case where reproduction of the video data 55 is initiated based on an instruction from a client (step S10), the correspondence table creation unit 32 performs, in step S100 as illustrated in FIG. 9, initializing processing illustrated in FIG. 10.

As illustrated in FIG. 10, in step S130, the correspondence table creation unit 32 creates a watching condition. The “watching condition” is a condition of a video (videos) that a client of the corresponding one of the terminal devices 18 wishes to watch, and is a condition of a segment file defined as an image-capturing target by the corresponding one of the terminal devices 18. The watching condition is not particularly limited. In a case where the video data 55 is related to, for example, baseball, a player, a team, or the like, specified by the client, may be cited. In addition, the watching condition may be one of the image-capturing devices 14 itself or an angle itself at which one of the image-capturing devices 14 image-captures, for example. A method for generating the watching condition is not particularly limited, and the client may input the above-mentioned watching condition from the input-output device 108 illustrated in FIG. 8. Note that a timing at which the watching condition is created is not limited to the present embodiment, and the storage unit 54 or the like may preliminarily store therein a watching condition created before initiating reproduction, for example.

In subsequent step S132, the correspondence table creation unit 32 transmits the created watching condition to the reproduction control device 12 via the cache server 16. A segment number (s: “s”=an integer and s=1 is satisfied in the present step) and information indicating an angle k selected based on the watching condition are transmitted by the reproduction control device 12 (see FIG. 15: the details thereof will be described later). Note that the segment number is a number assigned, in order of time, to each of segment files obtained by temporally dividing videos.

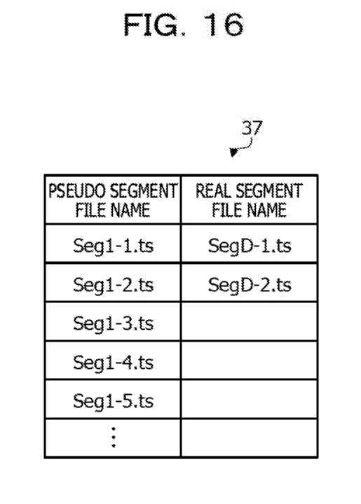

After, in subsequent step S134, the correspondence table creation unit 32 adds, to the correspondence table 37, the segment number (s) and the information indicating the angle k, which are received, the correspondence table creation unit 32 makes a transition to step S102 in the correspondence table creation processing. As illustrated in FIG. 16, the correspondence table 37 is an example of correspondence relationship information indicating a correspondence relationship between pseudo segment file names and real segment file names. Specifically, the correspondence table creation unit 32 generates a real segment file name from the segment number (s) and the information indicating the angle k, which are received, and causes the storage unit 36 to store therein the real segment file name while associating the real segment file name with a pseudo segment file name corresponding to the segment number (s).

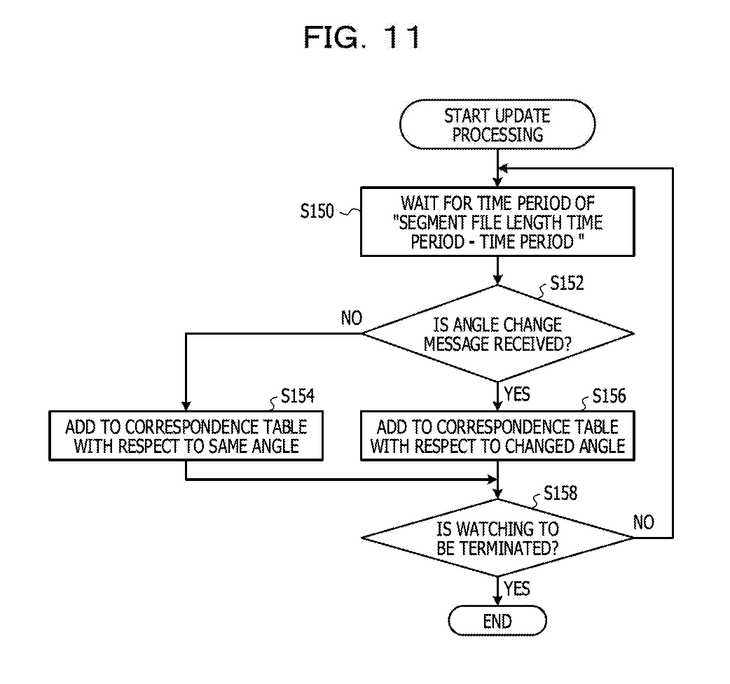

In step S102, the correspondence table creation unit 32 performs update processing illustrated in FIG. 11. As illustrated in FIG. 11, in step S150, the correspondence table creation unit 32 waits for a time period of “a segment file length time period−a time period α (a difference between the segment file length time period and the time period α)”. The segment file length time period is a reproduction time period of a segment file obtained by dividing a series of pieces of video data. The time period α is a time period taken to perform processing operations in steps S152 to S158, described later. The time period α may be preliminarily obtained based on an experiment or the like. Note that the present step is a step provided for performing the processing operation in subsequent step S152 for each segment file length time period. Therefore, in place of the present step, the correspondence table creation unit 32 may measure, by using a timer or the like, an elapsed time after performing step S152 and may determine whether or not the elapsed time reaches the segment file length time period.

In subsequent step S152, the correspondence table creation unit 32 determines whether or not an angle change message is received from the reproduction control device 12 via the cache server 16. In a case where no angle change message is received, negative determination is performed in step S152, and the correspondence table creation unit 32 makes a transition to step S154. In step S154, the correspondence table creation unit 32 generates a real segment file name for which the same angle is defined, and after adding the real segment file name to the correspondence table 37, the correspondence table creation unit 32 makes a transition to step S158.

On the other hand, in a case where an angle change message is received, affirmative determination is performed in step S152, and the correspondence table creation unit 32 makes a transition to step S156. The angle change message includes the segment number (s) and information indicating the changed angle k. In step S156, the correspondence table creation unit 32 generates a real segment file name for which a changed angle (information indicating the angle k included in the angle change message) is defined, and after adding the real segment file name to the correspondence table 37, the correspondence table creation unit 32 makes a transition to step S158.

In step S158, the correspondence table creation unit 32 determines whether or not to terminate reproduction. In the present embodiment, in a case of being instructed to terminate reproduction by a client by using the input-output device 108 or the like, the reproduction is terminated (see step S12 in FIG. 15). Note that, in the present embodiment, in a case where the reproduction is to be terminated in the corresponding one of the terminal devices 18, termination information indicating information that the reproduction is to be terminated is transmitted to the reproduction control device 12 via the cache server 16, as illustrated in FIG. 15 (step S13).

In a case of not terminating the reproduction, negative determination is performed in step S158, and the correspondence table creation unit 32 returns to step S150 and repeats the processing operations in steps S150 to S156. On the other hand, in a case of terminating the reproduction, affirmative determination is performed in step S158, and the correspondence table creation unit 32 terminates the present update processing. Upon terminating the present update processing, the correspondence table creation unit 32 terminates the correspondence table creation processing.

On the other hand, upon receiving a watching condition for each of the terminal devices 18, the reproduction control device 12 performs angle selection processing illustrated in FIG. 12.

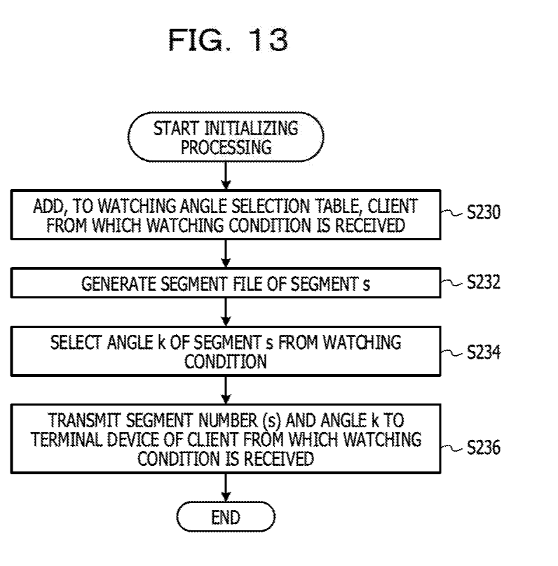

In step S200, the angle selection unit 50 performs initializing processing illustrated in FIG. 13. As illustrated in FIG. 13, in step S230, the angle selection unit 50 adds, to the watching angle selection table 57 illustrated in FIG. 5, a client (a corresponding one of the terminal devices 18) from which a corresponding one of the watching conditions is received. As illustrated in FIG. 5, for each of clients, the watching angle selection table 57 includes a “watching condition”, a “processing segment number”, an “angle”, and “changing information” while the “watching condition”, the “processing segment number”, the “angle”, and the “changing information” are associated with a corresponding one of client names. In the present step, first the angle selection unit 50 adds, to the watching angle selection table 57, a client name and a watching condition, which are received.

In subsequent step S232, for each of angles, the angle selection unit 50 divides a series of the pieces of video data 55, thereby generating a segment file of the segment s. Note that since, in the present initializing processing, data of the segment s corresponds to a head data obtained by dividing the video data 55 for the first time, a segment number becomes “1”.

In subsequent step S234, the angle selection unit 50 selects the angle k of the segment s from the watching condition. A selection method for an angle is not particularly limited. Image analysis may be performed on image data of the segment s, and selection may be performed based on a determination result of determination of whether or not being images corresponding to a corresponding one of watching conditions, for example. As a specific example, there may be cited a method in which a specified baseball player is defined as a watching condition and an angle, at which the relevant baseball player is more clearly (in a further enlarged size) caught, is selected based on image analysis. In addition, an operator or the like who operates the reproduction control device 12 may perform tagging for each of segment files and may select an angle, based on the relevant tag, for example. As a specific example, there may be cited a method in which a specified baseball player is defined as a watching condition and an operator or the like assigns a tag indicating the relevant baseball player, to a segment file in which the relevant baseball player is more clearly (in a further enlarged size) caught and that is included in segment files of all angles, the segment files of all angles each having the same segment number.

After, in subsequent step S236, transmitting, to the terminal device 18 of the client from which the watching condition is received, the segment number (s) and information indicating the angle k, the angle selection unit 50 terminates the present initializing processing and makes a transition to step S202 in the angle selection processing.

In step S202, the angle selection unit 50 increments the segment number (s) (s=s+1).

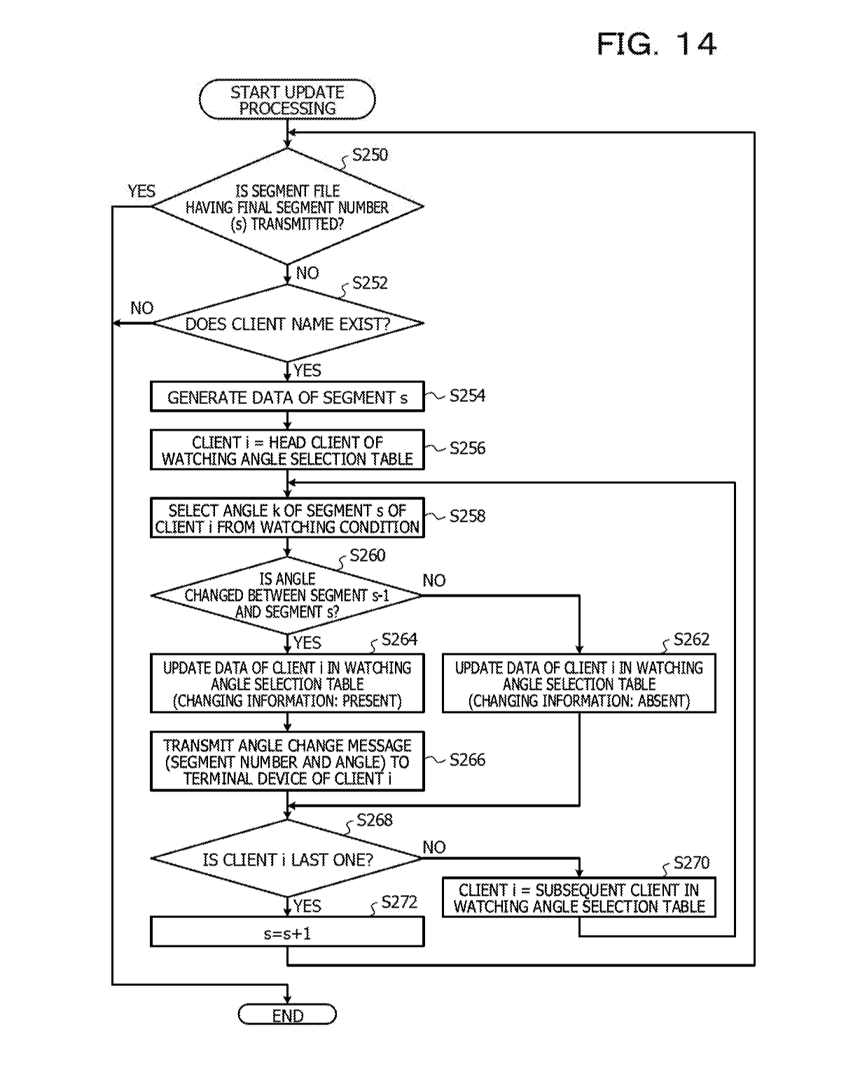

In subsequent step S204, the angle selection unit 50 performs update processing illustrated in FIG. 14. As illustrated in FIG. 14, in step S250, the angle selection unit 50 determines whether or not a segment file having the final segment number (s) is distributed. The segment file having the final segment number (s) is a segment file corresponding to an end of a time series of the pieces of video data 55 received from the image-capturing devices 14. In a case where the segment file having the final segment number (s) is distributed, affirmative determination is performed, the present update processing is terminated, and furthermore, the present angle selection processing is terminated. In a case where the segment file having the final segment number (s) is not distributed yet, negative determination is terminated, and the processing makes a transition to step S252.

In step S252, the angle selection unit 50 determines whether or not a client name exists (is stored) in the watching angle selection table 57. In the present embodiment, as illustrated in FIG. 15, in a case where termination information is received from one of the terminal devices 18, the reproduction control device 12 deletes, from the watching angle selection table 57, a client who terminates watching (step S20). In other words, only clients who currently perform watching are stored in the watching angle selection table 57. Therefore, a case where none of client names are stored in the watching angle selection table 57 indicates that no clients who currently perform watching (no terminal devices 18 that currently perform watching) exist.

In a case where negative determination is performed in step S252, the angle selection unit 50 terminates the present update processing and furthermore terminates the present angle selection processing. On the other hand, in a case where affirmative determination is performed in step S252, the angle selection unit 50 makes a transition to step S254.

In step S254, the angle selection unit 50 divides a series of the pieces of video data 55 for each of angles, thereby generating data of the segment s, and defines the data of the segment s as a segment file to which a segment file name is assigned.

In subsequent step S256, the angle selection unit 50 defines a client i as a head client of the watching angle selection table 57. In a case of the watching angle selection table 57 illustrated in FIG. 5, the client i is a client 3 (i=3).

In subsequent step S258, in the same way as step S234 in the above-mentioned initializing processing in the reproduction control device 12 (see FIG. 13), the angle selection unit 50 selects the angle k of the segment s of the client i from the watching condition.

In subsequent step S260, the angle selection unit 50 references the watching angle selection table 57 and determines whether or not an angle is changed between a segment s−1 and the segment s. In a case where no angle is changed, negative determination is performed, and the angle selection unit 50 makes a transition to step S262. After, in step S262, updating data of the client i in the watching angle selection table 57, the angle selection unit 50 makes a transition to step S268. Specifically, the angle selection unit 50 updates the “processing segment number” to the segment number “s”, and updates the “angle” to the selected angle “k”, and updates the “changing information” to “absent” indicating that a change is absent.

On the other hand, in a case where an angle is changed, affirmative determination is performed in step S260, and the angle selection unit 50 makes a transition to step S264. In step S264, the angle selection unit 50 updates data of the client i in the watching angle selection table 57. Specifically, the angle selection unit 50 updates the “processing segment number” to the segment number “s”, and updates the “angle” to the selected angle “k”, and updates the “changing information” to “present” indicating that a change is present.

In subsequent step S266, the angle selection unit 50 transmits, to the terminal device 18 of the client i, an angle change message including the segment number (s) and information indicating the angle k.

In subsequent step S268, the angle selection unit 50 determines whether or not the client i is a client stored at the end of the watching angle selection table 57. In a case where the client i is not a final client, negative determination is performed, and the angle selection unit 50 makes a transition to step S270.

After, in step S270, defining the client i as a subsequent client in the watching angle selection table 57, the angle selection unit 50 returns to step S258 and repeats the processing operations in steps S258 to S268. In a case of the watching angle selection table 57 illustrated in FIG. 5, the client i subsequent to the head client is a client 4 (i=4).

On the other hand, in a case where the client i is the final client, affirmative determination is performed in step S268, and the angle selection unit 50 makes a transition to step S272. After, in step S272, incrementing the segment number (s) (s=s+1), the angle selection unit 50 returns to step S250 and repeats the present update processing.

Note that, in a case where the correspondence table is created in the corresponding one of the terminal devices 18 as illustrated in FIG. 15, the cache server 16 transmits and receives various kinds of signals to and from the reproduction control device 12 and the corresponding one of terminal devices 18 and particularly performs no processing on these various kinds of signals.

In the video reproduction system 10A, in parallel to the processing for creating the correspondence table 37, processing for distributing segment files from the reproduction control device 12 to the terminal devices 18 is performed in response to requests from the terminal devices 18.

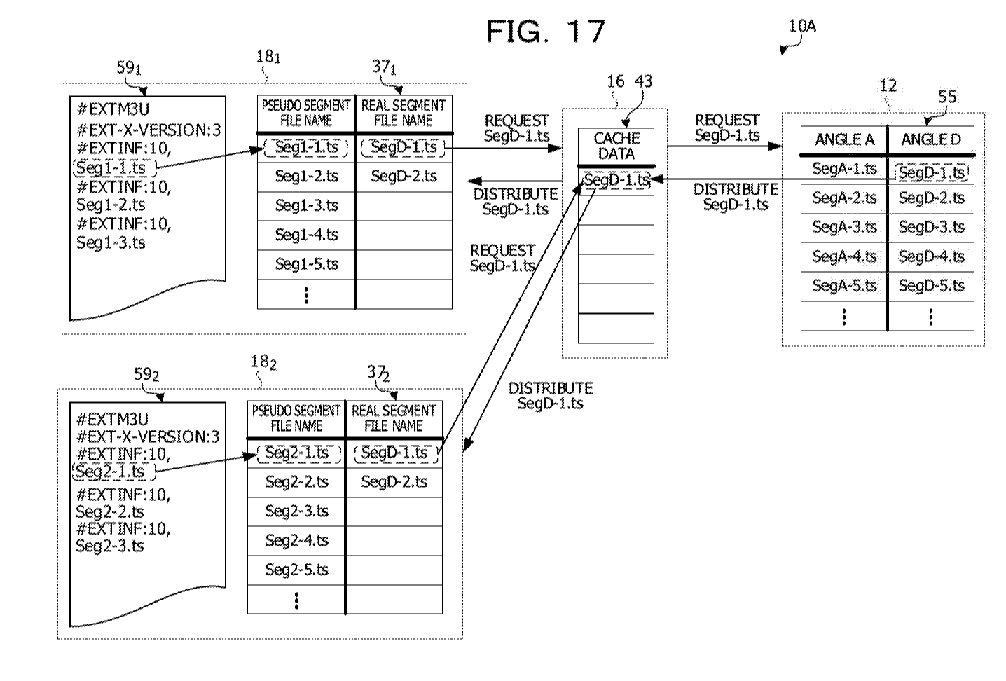

FIG. 17 is a diagram for explaining an outline of flows of segment files requested and distributed between the reproduction control device 12, the cache server 16, and terminal devices 18₁ and 18₂. The example illustrated in FIG. 17 illustrates a case where the translation unit 34 in the terminal device 18₁ selects, as a pseudo segment file name, “Seg1-1.ts” from a pseudo definition file 59₁. Note that “Seg1-1.ts” corresponds to a segment number of “1” (s=1). Based on a correspondence table 37₁, the translation unit 34 translates the pseudo segment file name of “Seg1-1.ts” into the real segment file name of “SegD-1.ts”. Note that “SegD-1.ts” is a segment file name of a segment file having the segment number of “1” (s=1) and corresponding to an angle D.

The translation unit 34 in the terminal device 18₁ outputs a segment file name indicating “SegD-1.ts”, thereby requesting to distribute a segment file. Upon receiving the relevant request, the cache server 16 confirms whether a segment file corresponding to the received segment file name of “SegD-1.ts” is stored as the cache data 43 in the storage unit 42. In a case where the segment file corresponding thereto is not stored, the cache server 16 outputs the segment file name of “SegD-1.ts” to the reproduction control device 12, thereby requesting to distribute the segment file. Upon receiving the relevant request, the reproduction control device 12 reads a segment file corresponding to the segment file name of “SegD-1.ts” from the video data 55 stored in the storage unit 54 and distributes the segment file to the cache server 16. In a case where the segment file is received from the reproduction control device 12, the cache server 16 causes the storage unit 42 to store therein the received segment file as the cache data 43. In addition, the cache server 16 distributes the received segment file to the terminal device 18₁.

On the other hand, in the terminal device 18₂, a case where the translation unit 34 selects, as a pseudo segment file name, “Seg2-1.ts” from the pseudo definition file 59₂ is illustrated. Note that “Seg2-1.ts” corresponds to the segment number of “1” (s=1). Based on a correspondence table 37₂, the translation unit 34 translates the pseudo segment file name of “Seg2-1.ts” into the real segment file name of “SegD-1.ts”.

The translation unit 34 outputs a segment file name indicating “SegD-1.ts”, thereby requesting to distribute a segment file. Upon receiving the relevant request, the cache server 16 confirms whether a segment file corresponding to the received segment file name of “SegD-1.ts” is stored as the cache data 43 in the storage unit 42. As illustrated in FIG. 17, after transmitting, to the terminal device 18₁, the segment file corresponding to “SegD-1.ts”, the segment file corresponding to “SegD-1.ts” is stored as the cache data 43.

Therefore, the cache server 16 distributes, to the terminal device 18₂, the segment file that is read from the cache data 43 and that corresponds to “SegD-1.ts”. In this case, the cache server 16 does not request the reproduction control device 12 to distribute the segment file.

In this way, in response to distribution requests for segment files, made by the terminal devices 18, the segment file is distributed by the reproduction control device 12 via the cache server 16 or by the cache server 16.

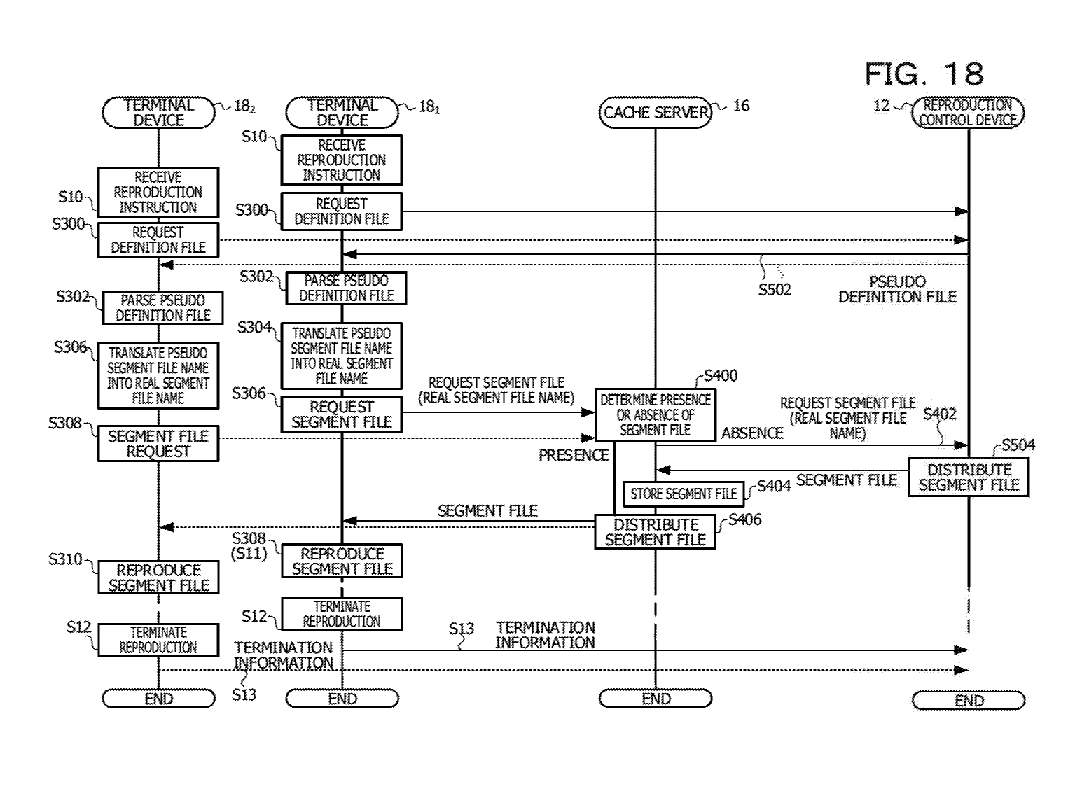

Next, an operation of each of the reproduction control device 12, the cache server 16, and the terminal devices 18 (18₁ and 18₂) will be described. FIG. 18 is a sequence diagram illustrating a flow of processing performed between the reproduction control device 12, the cache server 16, and the terminal devices 18 in order to distribute segment files. Note that, in FIG. 18, only two of the terminal devices (the terminal devices 18₁ and 18₂) included in the terminal devices 18 included in the video reproduction system 10A are described. Note that the terminal devices 18 included in the video reproduction system 10A each perform the same operation.

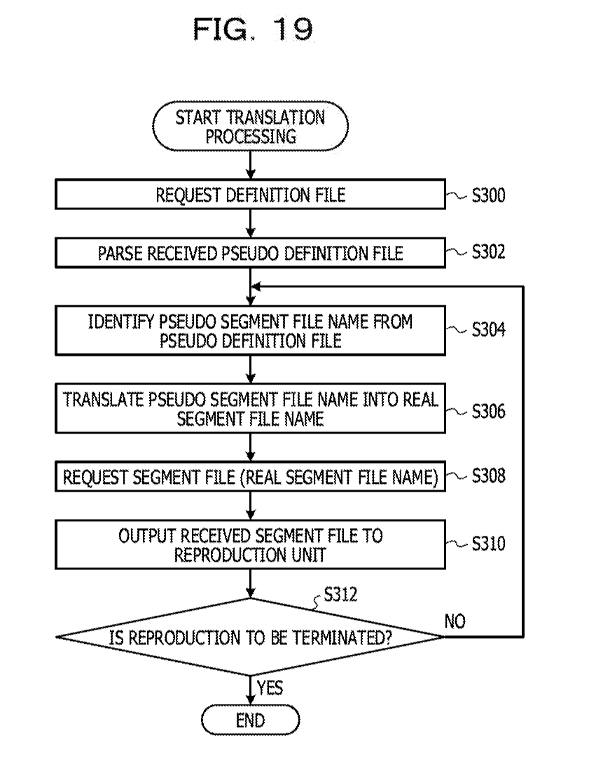

First, the operations of the terminal devices 18 will be described. As illustrated in FIG. 18, in each of the terminal devices 18, upon receiving a reproduction instruction (step S10), the translation device 22 performs translation processing illustrated in FIG. 19.

As illustrated in FIG. 19, in step S300, the translation unit 34 requests a definition file from the reproduction control device 12. In response to the relevant request, the pseudo definition file 59 illustrated in FIG. 20 is distributed by the reproduction control device 12. The pseudo definition file 59 is a so-called playlist. In the video reproduction system 10A of the present embodiment, the reproduction control device 12 transmits, to each of the terminal devices 18 as the pseudo definition file 59, a definition file in which a reproduction order is defined by pseudo segment file names in place of real segment file names. Regardless of the terminal devices 18, the pseudo definition file 59 is the same.

Upon receiving the pseudo definition file 59, in subsequent step S302 the translation unit 34 performs so-called parsing in which the received pseudo definition file 59 is analyzed, thereby extracting desired information.

In subsequent step S304, in accordance with the reproduction order defined in the pseudo definition file 59, the translation unit 34 identifies a pseudo segment file name requested to be distributed.

In subsequent step S306, based on the correspondence table 37, the translation unit 34 translates the pseudo segment file name into a real segment file name. Note that, in a case where translation of a segment file name is performed in the present step, a correspondence relationship between the pseudo segment file name requested to be distributed and the real segment file name has to be added to the correspondence table 37. Therefore, the present step is performed after the correspondence relationship is added to the correspondence table 37. As a specific example, it may be cited that the translation unit 34 performs the present step after a time period of one segment file length or two segment file lengths subsequent to addition of the correspondence relationship.

In subsequent step S308, the translation unit 34 requests to distribute a segment file. The terminal devices 18 of the present embodiment each outputs the real segment file name translated in the above-mentioned step S306, thereby requesting to distribute a segment file corresponding to the real segment file name.

In subsequent step S310, the translation unit 34 outputs the received (distributed) segment file to the reproduction unit 30 in the reproduction device 20. Based on the present processing, reproduction of the segment file is performed by the reproduction unit 30.

In subsequent step S312, the translation unit 34 determines whether or not to terminate reproduction. In a case of not terminating reproduction, negative determination is performed, and the translation unit 34 returns to step S304, thereby repeating the processing operations in steps S304 to S310. On the other hand, in a case of terminating reproduction, affirmative determination is performed, and the translation unit 34 terminates the present translation processing.

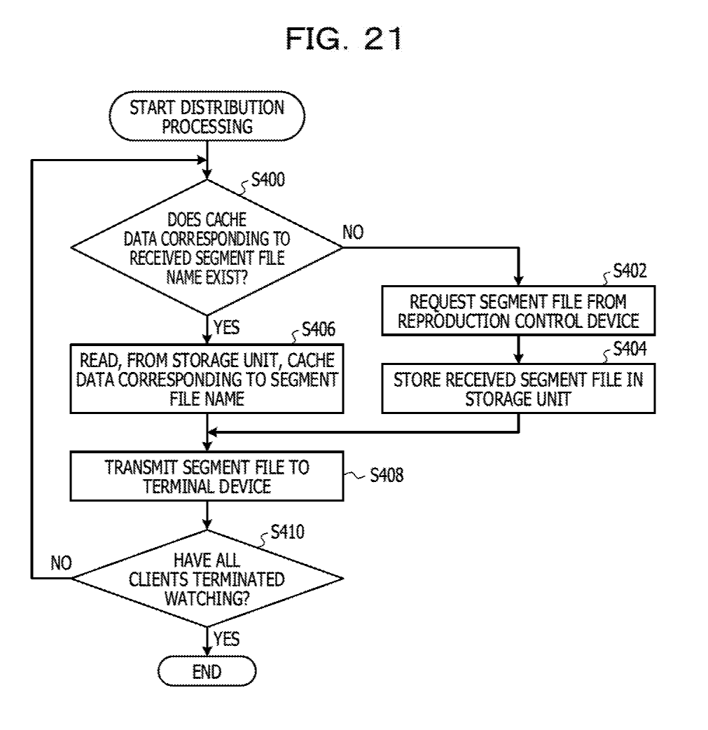

Next, an operation of the cache server 16 will be described. As illustrated in FIG. 18, upon receiving a request for a segment file from one of the terminal devices 18, the cache server 16 performs distribution processing illustrated in FIG. 21.

As illustrated in FIG. 21, in step S400, the distribution unit 40 references the storage unit 42 and determines whether or not the cache data 43 corresponding to a segment file name received from the corresponding one of the terminal devices 18 exists. In a case where the cache data 43 does not exist, negative determination is performed, and the processing makes a transition to step S402.

In step S402, the distribution unit 40 outputs the segment file name to the reproduction control device 12, thereby requesting to distribute the segment file. In response to the relevant request, the reproduction control device 12 distributes the segment file.

After, in subsequent step S404, causing the storage unit 42 to store therein the received segment file as the cache data 43, the distribution unit 40 makes a transition to step S408.

On the other hand, in a case where the cache data 43 corresponding to the received segment file name exists, affirmative determination is performed in step S400, and the distribution unit 40 makes a transition to step S406.

In step S406, from the cache data 43 in the storage unit 42, the distribution unit 40 reads, as the segment file, the cache data 43 corresponding to the received segment file name.

In subsequent step S408, the distribution unit 40 transmits the segment file to the corresponding one of the terminal devices 18.

In subsequent step S410, the distribution unit 40 determines whether or not all the clients have terminated watching (all the terminal devices 18 terminate reproduction). Based on, for example, pieces of termination information (see step S13 in FIG. 18) transmitted in a case where the respective terminal devices 18 terminate reproduction (see step S12 in FIG. 18), the distribution unit 40 determines whether or not all the clients (all the terminal devices 18) terminate reproduction.

In a case where one of the clients, who currently performs watching (one of the terminal devices 18, which currently performs reproduction), exists, negative determination is performed, and the distribution unit 40 returns to step S400, thereby repeating the present distribution processing. On the other hand, in a case where all the clients terminate watching, affirmative determination is performed, and the distribution unit 40 terminates the present distribution processing.

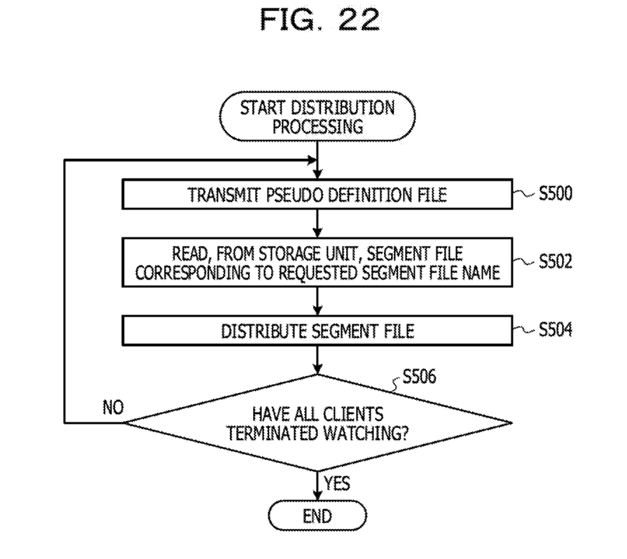

Next, an operation of the reproduction control device 12 will be described. As illustrated in FIG. 18, upon receiving, from one of the terminal devices 18, a request for a definition file, the reproduction control device 12 performs distribution processing illustrated in FIG. 22.

As illustrated in FIG. 22, in step S500, in response to the request, the distribution unit 52 transmits the pseudo definition file 59 to the corresponding one of the terminal devices 18 via the cache server 16. After this, as described above, a real segment file name is received from the corresponding one of the terminal devices 18 via the cache server 16 or from the cache server 16. Accordingly, distribution of a segment file corresponding to the relevant real segment file name is requested.

In subsequent step S502, the distribution unit 52 reads the segment file corresponding to the requested real segment file name from segment files of the video data 55 stored in the storage unit 54.

In subsequent step S504, the distribution unit 52 distributes the read segment file.

In subsequent step S506, the distribution unit 52 determines whether or not all the clients have terminated watching (all the terminal devices 18 terminate reproduction). As a determination method, the same processing operation as that in step S410 (see FIG. 21) in the above-mentioned distribution processing in the cache server 16 may be performed.

In a case where one of the clients, who currently performs watching (one of the terminal devices 18, which currently performs reproduction), exists, negative determination is performed, and the distribution unit 52 returns to step S500, thereby repeating the present distribution processing. On the other hand, in a case where all the clients terminate watching, affirmative determination is performed, and the distribution unit 52 terminates the present distribution processing.

In this way, in the video reproduction system 10A of the present embodiment, the terminal devices 18 each perform reproduction of a segment file, based on the pseudo definition file 59. In the storage unit 36 in each of the terminal devices 18, the correspondence table 37 indicating a correspondence relationship between pseudo segment file names and real segment file names is stored. Based on information that is used for updating the correspondence table 37 and that is output by the angle selection unit 50 in the reproduction control device 12, the correspondence table creation unit 32 in each of the terminal devices 18 creates and updates the correspondence table 37. Based on the correspondence table 37, the translation unit 34 in each of the terminal devices 18 translates, into a real segment file name, a pseudo segment file name in the pseudo definition file 59, which is requested to be distributed, and transmits the real segment file name, thereby requesting to distribute a segment file. The reproduction control device 12 reads, from the storage unit 54, segment files corresponding to the respective received real segment file names, thereby distributing the segment files to the terminal devices 18.

In addition, in the video reproduction system 10A of the present embodiment, segment files are requested and distributed between the reproduction control device 12 and the terminal devices 18 via the cache server 16. In the storage unit 42, the cache server 16 stores, as the cache data 43, segment files distributed by the reproduction control device 12.

Therefore, in a case where some of the terminal devices 18 request to distribute the same segment file, the cache server 16 distributes the relevant segment file stored as the cache data 43, to the terminal devices 18 that request later. In this case, since no segment file is distributed by the reproduction control device 12, a load on a network, in particular, on the network 15 to which the reproduction control device 12 and the cache server 16 are coupled is reduced.

In a case where, unlike the video reproduction system 10A of the present embodiment, the reproduction control device 12 includes the correspondence table 37, a load on the network 15 is increased, compared with the video reproduction system 10A.

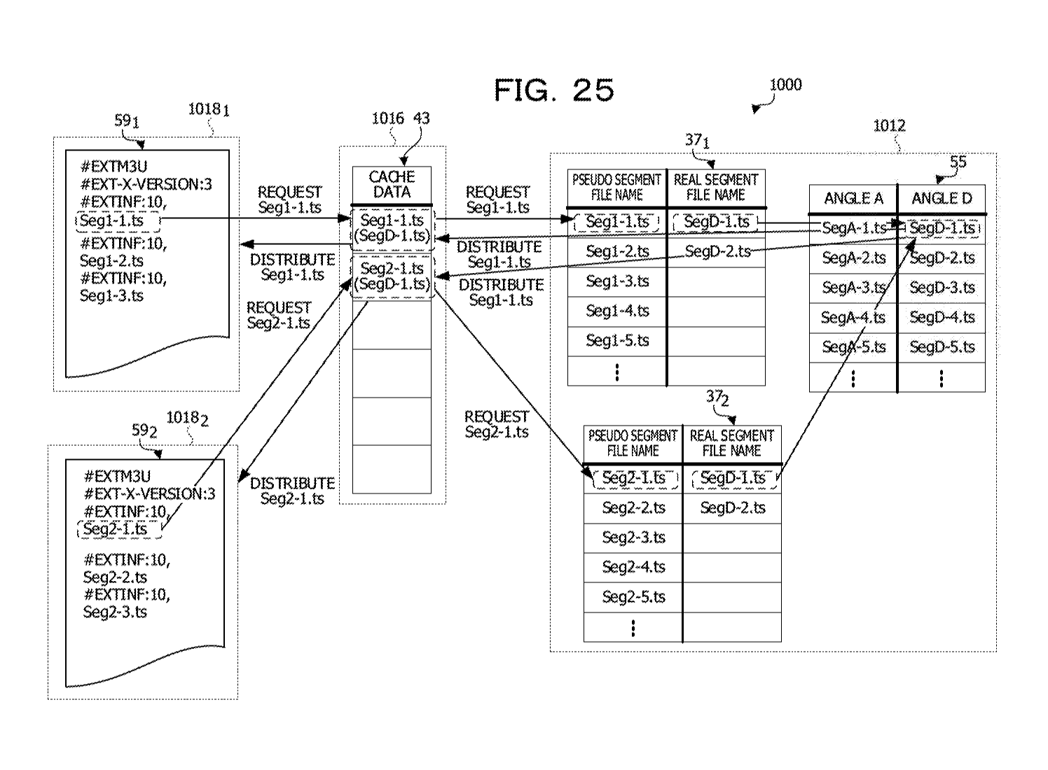

As for, for example, a video reproduction system 1000, FIG. 25 illustrates an example of the video reproduction system 1000 in which a reproduction control device 1012 includes correspondence tables 37₁ and 37₂ created for terminal devices 1018 (1018₁ and 1018₂), respectively.

In the example illustrated in FIG. 25, the terminal device 1018₁ selects, as a pseudo segment file name, “Seg1-1.ts” from a pseudo definition file 59₁ and requests to distribute “Seg1-1.ts”. A cache server 1016 requests the reproduction control device 1012 to distribute “Seg1-1.ts”. The reproduction control device 1012 references the correspondence table 37₁ and translates the pseudo segment file name of “Seg1-1.ts” into the real segment file name of “SegD-1.ts”. In addition, the reproduction control device 1012 reads, from the video data 55, a segment file corresponding to the segment file name of “SegD-1.ts” and distributes the segment file to the cache server 1016. The cache server 1016 causes the received segment file to be stored as the cache data 43. Here, the file name of the cache data 43 becomes the segment file name of “Seg1-1.ts” requested by the terminal device 1018₁.

In addition, in the example illustrated in FIG. 25, the terminal device 1018₂ selects, as a pseudo segment file name, “Seg2-1.ts” from a pseudo definition file 59₂ and requests to distribute “Seg2-1.ts”. The cache server 1016 requests the reproduction control device 1012 to distribute “Seg2-1.ts”. The reproduction control device 1012 references the correspondence table 37₂ and translates the pseudo segment file name of “Seg2-1.ts” into the real segment file name of “SegD-1.ts”. In addition, the reproduction control device 1012 reads, from the video data 55, a segment file corresponding to the segment file name of “SegD-1.ts” and distributes the segment file to the cache server 1016. The cache server 1016 causes the received segment file to be stored as the cache data 43. Here, the file name of the cache data 43 becomes the segment file name of “Seg2-1.ts” requested by the terminal device 1018₂.

In this way, while being segment files (“SegD-1.ts”) each having the same content, the segment file “Seg1-1.ts” and the segment file “Seg2-1.ts” each have a different segment file name. Therefore, as illustrated in FIG. 25, in the cache server 1016, the same segment file turns out to be stored as the cache data 43. In addition, despite the fact that the segment file requested to be distributed is stored, as the cache data 43, in the cache server 1016, the relevant segment file turns out to be distributed by the reproduction control device 1012.

Accordingly, in the video reproduction system 1000 illustrated in FIG. 25, a load on a network to which the reproduction control device 1012 is coupled is increased, compared with the video reproduction system 10A of the present embodiment. In addition, the same data turns out be redundantly stored in the cache data 43 in the cache server 1016.

In contrast with this, as described above, in the video reproduction system 10A of the present embodiment, a load on a network, in particular, on the network 15 to which the reproduction control device 12 and the cache server 16 are coupled is reduced.

### Second Embodiment

Next, a second embodiment of the disclosed technology will be described. Note that the same symbol is assigned to the same portion as that in the present embodiment and the description thereof will be omitted.

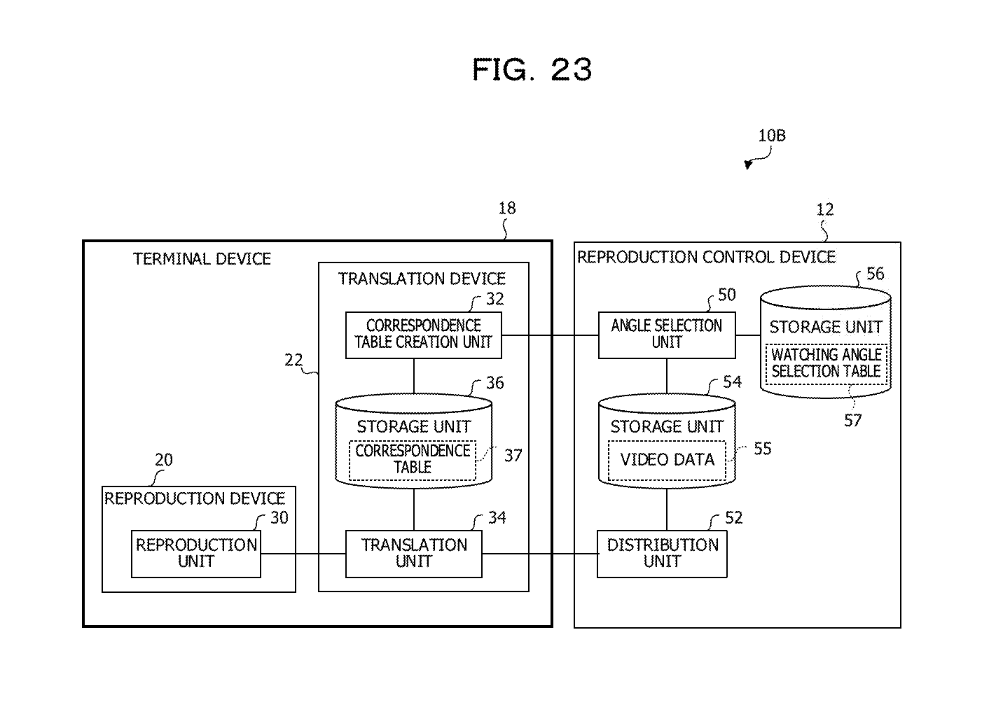

As illustrated in FIG. 23, a video reproduction system 1013 of the present embodiment is different from the video reproduction system 10A of the first embodiment in that no cache server 16 is included.

In this case, one of the terminal devices 18 and the reproduction control device 12 perform communication with each other via no cache server 16. Therefore, all segment files requested by the corresponding one of the terminal devices 18 are directly distributed to the corresponding one of the terminal devices 18 by the reproduction control device 12.

Note that operations of the reproduction control device 12 and the corresponding one of the terminal devices 18 are the same as those of the first embodiment.

### Third Embodiment

Next, a third embodiment of the disclosed technology will be described. Note that the same symbol is assigned to the same portion as that in the present embodiment and the description thereof will be omitted.

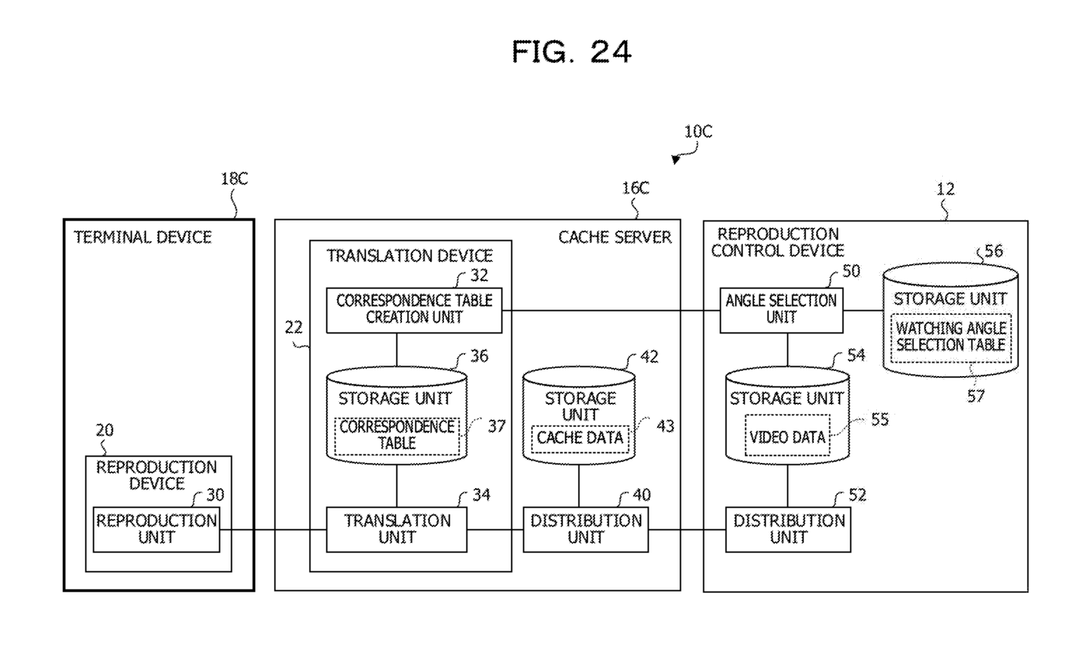

As illustrated in FIG. 24, a video reproduction system 10C of the present embodiment is different from the video reproduction system 10A of the first embodiment in that a cache server 16C includes the translation device 22 on behalf of a terminal device 18C.

In this case, in the cache server 16C, processing based on the translation device 22 is performed. Specifically, the translation device 22 in the cache server 16C performs the correspondence table creation processing (see FIG. 9), the initializing processing (see FIG. 10), the update processing (see FIG. 11), and the translation processing (see FIG. 19) in the first embodiment.

The other operations of the reproduction control device 12, the cache server 16C, and the terminal device 18C are the same as those of the first embodiment.

As described above, in each of the video reproduction systems 10A to 10C of the respective above-mentioned embodiments, the reproduction control device 12 divides each of the pieces of video data 55, which serves as time-series data, into pieces of data in accordance with a time series, thereby generating segment files. The reproduction control device 12 assigns, to a segment file, a segment file name that includes information indicating one of the pieces of video data 55 and information indicating the order of a time series.

Each of the terminal devices 18 (or the cache server 16) reproduces divided files, based on the pseudo definition file 59 in which pseudo segment file names are defined in a reproduction order of reproducing segment files.

Each of the terminal devices 18 (or the cache server 16) translates a pseudo segment file name into a real segment file name, based on the correspondence table 37 indicating a correspondence relationship between pseudo segment file names and real segment file names.

Each of the terminal devices 18 (or the cache server 16) transmits a real segment file name, thereby requesting the reproduction control device 12 to distribute a segment file.

At a time of being requested to distribute, the reproduction control device 12 selects a segment file, to which a real segment file name is assigned as a segment file name, from the video data 55, thereby distributing the segment file to a corresponding one of the terminal devices 18.

In this way, in each of the video reproduction systems 10A to 10C of the respective above-mentioned embodiments, distribution of a segment file is requested based on a real segment file name equal to a segment file name assigned to a segment file stored in the reproduction control device 12. Therefore, in a case of being requested to distribute the same segment file by some of the terminal devices 18, the reproduction control device 12 does not have to distribute a segment file for each of the relevant terminal devices 18.

Therefore, according to the video reproduction systems 10A to 10C of the respective above-mentioned embodiments, it is possible to reduce a load on a network via which the video data 55 (segment files) is distributed. Since the load on the network is reduced, it is possible to improve the transfer efficiency of data according to the video reproduction systems 10A to 10C of the respective above-mentioned embodiments.

In addition, in each of the video reproduction systems 10A to 10C of the respective above-mentioned embodiments, in the correspondence table 37, real segment file names and pseudo segment file names of segment files selected in accordance with a watching condition for each of the terminal devices 18 (the clients) are associated with each other. Therefore, it is possible for each of the clients to watch videos selected in accordance with a preference of the relevant client oneself, by using a corresponding one of the terminal devices 18.

Note that while, in each of the above-mentioned embodiments, a case where the video data 55 to be distributed is the video data 55 image-captured at multiple angles by the image-capturing devices 14 is described, the video data 55 is not limited to this. The video data 55 is pieces of video data continuous in a time-series manner and only has to include pieces of video data equal in a time-series manner. Video data corresponding to baseball relay distributed in the same time zone and video data corresponding to a live video based on artists may be included, for example.

In addition, the video data 55 is not limited to video data of so-called live broadcasting, broadcasted in real time, and may be preliminarily acquired video data (video data of a movie or the like, for example).

In addition, while, in the individual above-mentioned embodiments, cases where the video reproduction systems 10A to 10C each include the terminal devices 18 are described, the present technology may be applied to a video reproduction system including only one of the terminal devices 18.

In addition, while, in each of the above-mentioned embodiments, segment file names and real segment file names are used as examples of identification information of the disclosed technology and pseudo segment file names are used as examples of pseudo identification information thereof, each of the identification information and the pseudo identification information is not limited to these. If the identification information and the pseudo identification information each include information indicating one of a series of pieces of video data included in the video data 55 and information indicating the order (reproduction order) of a time series, each of the identification information and the pseudo identification information is not particularly limited.

In addition, even in a case where the video data 55 includes only a series of pieces of video data, the present technology may be applied if the relevant pieces of video data are preliminarily stored for a certain amount of time or more. In a case where pieces of video data corresponding to respective “introduction”, “development”, “turn”, and “conclusion” in, for example, a four-frame cartoon are preliminarily stored as the video data 55, it becomes possible to distribute, in response to a request of one of the terminal devices 18, in the order of, for example, “conclusion”, “introduction”, “development”, and “turn”, by changing an order.

In addition, in each of the above-mentioned embodiments, a state in which the reproduction control program 70 is preliminarily stored (installed) in the storage unit 63 in the computer 60 is described. However, the reproduction control program 70 may be provided in a form of being recorded in the recording medium 69. In addition, in the same way, a state in which the cache program 90 is preliminarily stored (installed) in the storage unit 83 in the computer 80 is described. However, the cache program 90 may be provided in a form of being recorded in the recording medium 89. In addition, in the same way, a state in which the translation program 110 and the reproduction program 114 are preliminarily stored (installed) in the storage unit 103 in the computer 100 is described. However, at least one of the translation program 110 and the reproduction program 114 may be provided in a form of being recorded in the recording medium 109. As each of the recording media 69, 89, and 109, a Compact Disc read only memory (CD-ROM), a Digital Versatile Disk read only memory (DVD-ROM), a universal serial bus (USB) memory, and so forth may be cited, for example. In addition, each of the reproduction control program 70, the cache program 90, the translation program 110, and the reproduction program 114 may be downloaded from an external device or the like via a communication line such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distribution method executed by a computer, the distribution method comprising:
assigning, to each of files including divided video data which is divided in accordance with a time series, identification information that includes information indicating one of the video data and information indicating an order of the time series;
receiving, from a terminal device that reproduces the files, a distribution request for video data based on a pseudo definition file in which pseudo identification information is defined in a reproduction order of reproducing the files;
selecting, based on relationship information indicating a correspondence relationship between the pseudo identification information and the identification information, a file corresponding to the distribution request from among the files; and
distributing the selected file to the terminal device.

2. The distribution method according to claim 1, wherein the pseudo definition file is stored in another computer different from the computer.

3. The distribution method according to claim 2, wherein the other computer is the terminal device.

4. The distribution method according to claim 3, wherein the distribution request includes the identification information translated from the pseudo identification information, based on the relationship information.

5. The distribution method according to claim 4, wherein the selecting selects, from among the files, the file to which the identification information included in the distribution request is assigned.

6. The distribution method according to claim 2, further comprising:
receiving, from the terminal device, a condition related to a reproduction target to be reproduced by the terminal device,
wherein
the selecting selects the file satisfying the received condition, from among files for which the time series of the video data is the same, and
information for identifying identification information assigned to the file is transmitted to the other computer.

7. The distribution method according to claim 1, wherein the video data is obtained by image-capturing an image-capturing target at a different angle.

8. A distribution request method executed by a computer, the distribution request method comprising:
identifying pseudo identification information related to a file to serve as a reproduction target, based on a pseudo definition file in which pseudo identification information is defined in a reproduction order of reproducing files including divided video data respectively, which is divided in accordance with a time series;
based on relationship information indicating a correspondence relationship between identification information indicating an order of time series of the video data and the pseudo identification information, translating the identified pseudo identification information into the identification information; and
transmitting, to another computer storing the file, a distribution request including the translated identification information.

9. The distribution request method according to claim 8, further comprising:
transmitting, to the other computer, a condition related to the reproduction target;
receiving, from the other computer, information for identifying the identification information assigned to a file satisfying the condition; and
creating the relationship information while associating, with the pseudo identification information, the identification information identified based on the information for identifying the identification information.

10. An information processing device comprising:
a memory; and
a processor coupled to the memory and configured to:
assign, to each of files including divided video data which is divided in accordance with a time series, identification information that includes information indicating one of the video data and information indicating an order of the time series,
receive, from a terminal device that reproduces the files, a distribution request for video data based on a pseudo definition file in which pseudo identification information is defined in a reproduction order of reproducing the files,
select, based on relationship information indicating a correspondence relationship between the pseudo identification information and the identification information, a file corresponding to the distribution request from among the files, and
distribute the selected file to the terminal device.

11. The information processing device according to claim 10, wherein the pseudo definition file is stored in another computer different from the computer.

12. The information processing device according to claim 11, wherein the other computer is the terminal device.

13. The information processing device according to claim 12, wherein the distribution request includes the identification information translated from the pseudo identification information, based on the relationship information.

14. The information processing device according to claim 13, wherein the file to which the identification information included in the distribution request is assigned is selected from among the files.

15. The information processing device according to claim 11, wherein the processor is further configured to:
receive, from the terminal device, a condition related to a reproduction target to be reproduced by the terminal device,
select the file satisfying the received condition, from among files for which a time series of each of the video data is the same, and
transmit, to the other computer, information for identifying identification information assigned to a file.

16. The information processing device according to claim 10, wherein each of the video data is obtained by image-capturing an image-capturing target at a different angle.
